(19) United States
(12) Patent Application Publication
(10) Pub. No.: US 2013/0285891 A1
(43) Pub. Date: Oct. 31, 2013

(54) LCD PANEL AND PIXEL ELECTRODE THEREOF

(71) Applicant: Xin Zhang, Shenzhen (CN)

(72) Inventor: Xin Zhang, Shenzhen (CN)

(73) Assignee: SHENZHEN CHINA STAR OPTOELECTRONICS TECHNOLOGY CO., LTD., Shenzhen (CN)

(21) Appl. No.: 13/522,705

(22) PCT Filed: Apr. 27, 2012
(86) PCT No.: PCT/CN2012/074800

§ 371 Date: Jul. 17, 2012

(30) Foreign Application Priority Data
Apr. 26, 2012 (CN) 201210125057.5

(51) Int. Cl. G09G 3/36

(52) U.S. Cl. 345/90

(57) ABSTRACT

The present invention discloses a pixel electrode of a liquid crystal display (LCD) panel. The pixel electrode has a specific pattern or layout. The pixel electrode has a peripheral portion and branches surrounded by the peripheral portion. The pixel electrode further has at least one opening located inside a region surrounded by the peripheral portion. Each branch has a part connecting to the peripheral portion and said part has a width smaller than respective widths of other parts in each branch. The pixel electrode can improve the aperture rate of the LCD panel and suppress the appearance of disclination line at the center domain of the pixel.

### BACKGROUND OF THE INVENTION

1. Field of the Invention

The present invention relates to a liquid crystal display (LCD) panel and a pixel electrode, and more particularly, to a LCD panel and a pixel electrode having a peripheral portion and branches capable of improving an aperture rate of the panel.

2. Description of Prior Art

A display with multiple functions is a key element for use in current consumer electronic products. The novelty and colorful displays with high resolution, e.g., LCDs, are indispensable components used in various electronic products such as display screens for personal computers, notebook computers, personal digital assistants (PDAs), digital cameras, and mobile phones.

A LCD comprises a backlight module and a LCD panel. A traditional LCD panel comprises two substrates and a liquid crystal (LC) layer sandwiched by the two substrates. In general, an alignment film is formed on both of the two substrates during the LCD panel manufacturing process so that LC molecules can be arranged in a specific direction. In a traditional method of forming the alignment film, an alignment material is coated and then the alignment material undergoes an alignment process.

Currently, a technology called ploymer stabilized vertical alignment (PSVA) has been developed in the industry. As to the PSVA technology, a LC material is mixed with monomers having an appropriate concentration, and then the mixed LC material is shaken uniformly. Next, the mixed LC material is placed on a heater and heated until it achieves isotropy. When the mixed LC material reaches a room temperature, it tends to go back to a nematic state. Subsequently, the mixed LC material is injected into a LC cell, and a voltage is applied to the LC cell. The voltage makes the LC molecules be arranged stably in the cell. Then, the mixed LC material is polymerized by exposing under ultraviolet (UV) light or by heating in order to form a polymer layer. In this way, alignment stability can be achieved.

In general, for a pixel structure used in a PSVA LCD panel, alignment slits formed in a pixel electrode can make the LC molecules be aligned in a specific direction. Refer to FIG. 1, which is an enlarged diagram of a pixel in a conventional PSVA LCD panel. As shown in FIG. 1, the LCD panel comprises a data line DL, a scan line SL, a thin-film transistor (TFT) 114, and a pixel electrode 110. The pixel electrode 110 disposed within the pixel domain has a snowflake-like pattern (or layout). The pixel electrode 110 comprises a vertical central main trunk 111, a horizontal central main trunk 112, and branches 113 slanted away from the X axis by ±45 degrees and by ±135 degrees. The vertical main trunk 111 and the horizontal main trunk 112 divide a pixel into four equal domains. The branches 113 slanted at a 45-degree angle are paved inside the four domains.

Therefore, a snowflake-like electrode pattern forming an upper-lower and left-right mirror-image symmetry is completed.

In this electrode pattern, a part of the branches 113 is electrically connected to the TFT 114 for transmitting the voltage from the scan line SL to the pixel electrode 110.

Refer to FIG. 2, which illustrates an alignment of the LC molecules when a constant voltage (e.g., 4 volts) is applied to the pixel electrode 110 shown in FIG. 1. As shown in FIG. 2, when the voltage is applied to the snowflake-like pixel electrode 110, the LC molecules are slanted gradually from the outer part of the pixel electrode 110 to the inner part the pixel electrode 110. The slanted angle of the LC molecules in each domain extends in the direction of the branches 113 of the same domain. The slanted angles of LC molecules in each of the four domains are ±45 and ±135 degrees, respectively. The slanted LC molecules of the four domains are all directed toward the center of the pixel domain. For a detailed explanation, as shown in FIG. 2, the included angles between the slanted directions of the LC molecules in each domain and the X axis (i.e., the scan line) are respectively −135 degrees in the first quadrant, −45 degrees in the second quadrant, 45 degrees in the third quadrant, and 135 degrees in the forth quadrant.

Refer to FIG. 3, which is a cross-sectional view of slanted directions of the LC molecules along a dash line A-B-C shown in FIG. 2. As shown in FIG. 3, on the cross section (perpendicular to the sheet surface) along the dash line shown in FIG. 2, the LC molecules are slanted from the peripheral region to the center of the pixel electrode 110. The slanted LC molecules are directed toward the inside of the pixel.

It is notified that, the conventional pixel electrode 110 highly relies on the vertical main trunk 111 and the horizontal main trunk 112. Basically, the vertical main trunk 111 and the horizontal main trunk 112 are opaque domains. This is because the LC molecules located at positions corresponding to the vertical main trunk 111 and the horizontal main trunk 112 are directed toward the main trunks. The included angle between the LC molecules positioned corresponding to the vertical main trunk 111 and the X axis is zero degree; the included angle between the LC molecules positioned corresponding to the horizontal main trunk 112 and the X axis is 90 degrees. The included angle between an upper polarizer film and the X axis is fixed to zero degree; the included angle between a lower polarizer film and the X axis is fixed to 90 degrees. Therefore, the transmittance of the regions corresponding to the vertical main trunk 111 and of the horizontal main trunk 112 is zero according to a formula for transmittance calculation. On the other hand, both of the vertical main trunk 111 and the horizontal main trunk 112 occupies a very large area, and this will decrease an aperture rate of the LCD panel.

As a result, the industry needs to develop a pixel electrode pattern capable of possessing a larger aperture rate.

### SUMMARY OF THE INVENTION

An object of the present invention is to provide a LCD panel and a pixel electrode for improving an aperture rate of the LCD panel, thereby solving the above-mentioned problems occurred in conventional skills.

According to an embodiment of the present invention, a pixel electrode of a LCD panel is disclosed. The LCD panel comprises a scan line, a data line, a switch unit, and a pixel domain, the scan line and the data line being electrically connected to the switch unit, the pixel electrode being disposed in the pixel domain, the pixel electrode comprising: a peripheral portion electrically connected to one terminal of the switch unit; a plurality of branches surrounded by the peripheral portion and connected to the peripheral portion; and at least one opening located inside a region surrounded by the peripheral portion, the opening dividing the plural branches into at least two domains; wherein each branch has a part connecting to the peripheral portion and said part has a width smaller than respective widths of other parts in each branch.

According to another embodiment of the present invention, a LCD panel is disclosed. The LCD panel comprises a scan line, a data line, a switch unit, a pixel electrode, and a pixel domain, the scan line and the data line being electrically connected to the switch unit, the pixel electrode being disposed in the pixel domain, the pixel electrode comprising: a peripheral portion electrically connected to one terminal of the switch unit; a plurality of branches surrounded by the peripheral portion and connected to the peripheral portion; and at least one opening located inside a region surrounded by the peripheral portion, the opening dividing the plural branches into at least two domains; wherein each branch has a part connecting to the peripheral portion and said part has a width smaller than respective widths of other parts in each branch.

In contrast to the prior art, the pixel electrode and the LCD panel of the present invention comprises a peripheral portion and branches. The present invention reduces or removes the domain of the central main trunk in the prior art such that the opaque domains are reduced significantly. As a result, an aperture rate of the LCD panel is successfully improved. Moreover, in the pixel electrode of the present invention, the contour of the part where each branch and the peripheral portion are connected is shrunk. The LC molecules at this part are slanted very well. Therefore, it is unlikely to squeeze other LC molecules in opposite direction, and thus the present invention can solve the problem of disclination line appeared at the center domain of the pixel electrode.

To make above content of the present invention more easily understood, it will be described in details by using preferred embodiments in conjunction with the appending drawings.

### BRIEF DESCRIPTION OF THE DRAWINGS

FIG. 1 is an enlarged diagram showing a pixel in a conventional PSVA LCD panel.

FIG. 2 is a diagram illustrating an alignment of LC molecules when a constant voltage is applied to a pixel electrode shown in FIG. 1.

FIG. 3 is a cross-sectional view of slanted directions of LC molecules along a dash line A-B-C shown in FIG. 2

FIG. 4 is an enlarged diagram showing a pixel in a LCD panel according to a first embodiment of the present invention.

FIG. 5 is a diagram illustrating an alignment of LC molecules when a voltage is applied to a pixel electrode shown in FIG. 4.

FIG. 6 is a cross-sectional view of slanted directions of LC molecules along a dash line A-B-C shown in FIG. 5.

FIG. 7 is an enlarged diagram of a pixel in a LCD panel according to a second embodiment of the present invention.

FIG. 8 is an enlarged diagram showing branches of FIG. 7.

FIG. 9A and FIG. 9B are structural diagrams showing that a part where a branch and a peripheral portion are connected has a curve-shaped edge at one side and two side, respectively.

FIG. 9C and FIG. 9D are structural diagrams showing that a part where a branch and a peripheral portion are connected has a saw-toothed edge at one side and two side, respectively.

FIGS. 10A to 10E are schematic diagrams showing a pixel electrode having a cross-shaped opening according to a third embodiment of the present invention.

FIGS. 10F to 10J are schematic diagrams showing a pixel electrode having a horizontal straight opening according to a fourth embodiment of the present invention.

FIGS. 10K to 10O are schematic diagrams showing a pixel electrode having a vertical straight opening according to a fifth embodiment of the present invention.

FIGS. 10P to 10T are schematic diagrams showing a pixel electrode having an X-shaped opening according to a sixth embodiment of the present invention.

FIGS. 10U to 10Y are schematic diagrams showing a pixel electrode having a snowflake-like opening according to a seventh embodiment of the present invention.

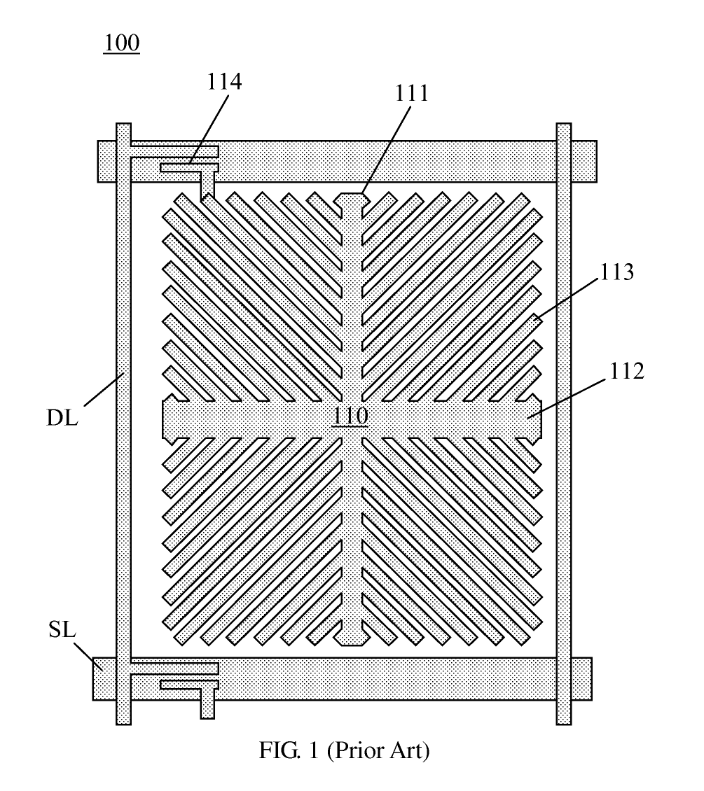

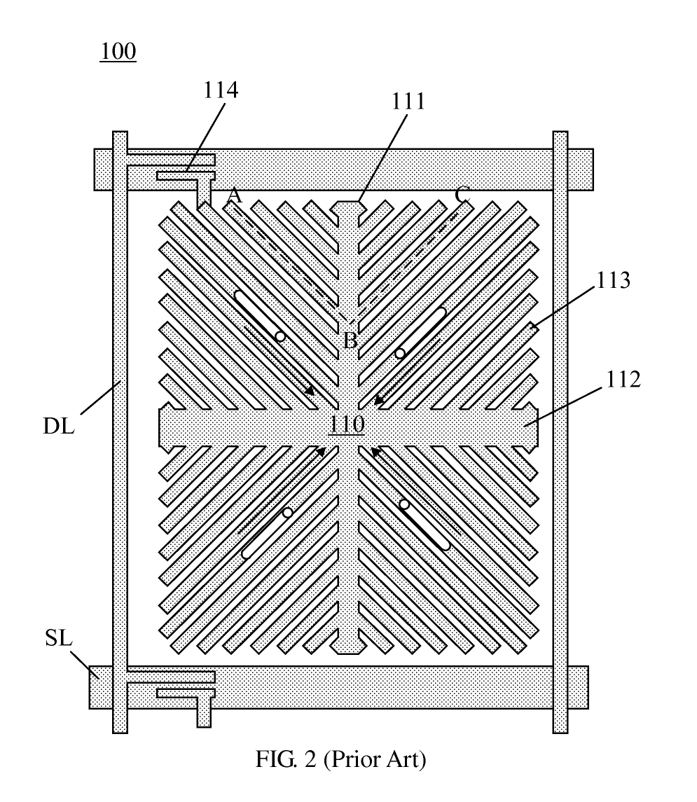

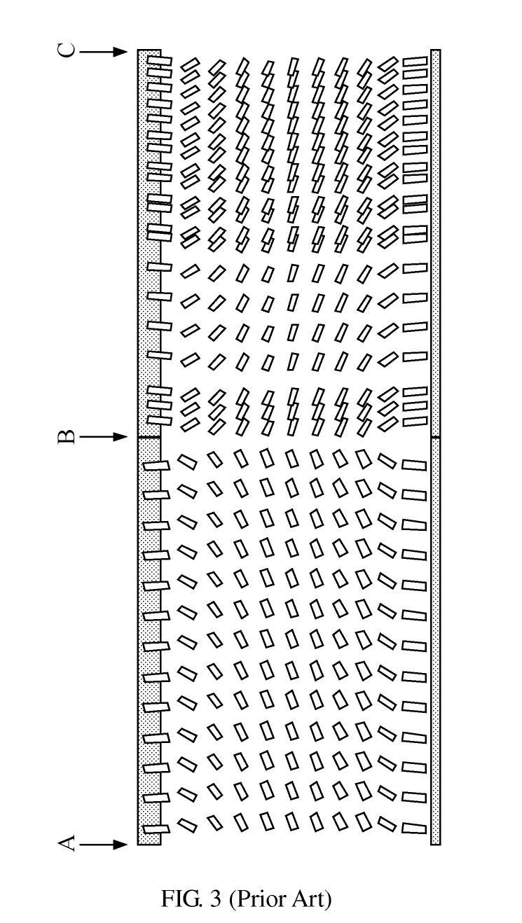

### DETAILED DESCRIPTION OF THE PREFERRED EMBODIMENTS

The following descriptions for the respective embodiments are specific embodiments capable of being implemented for illustrations of the present invention with referring to appended figures. Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

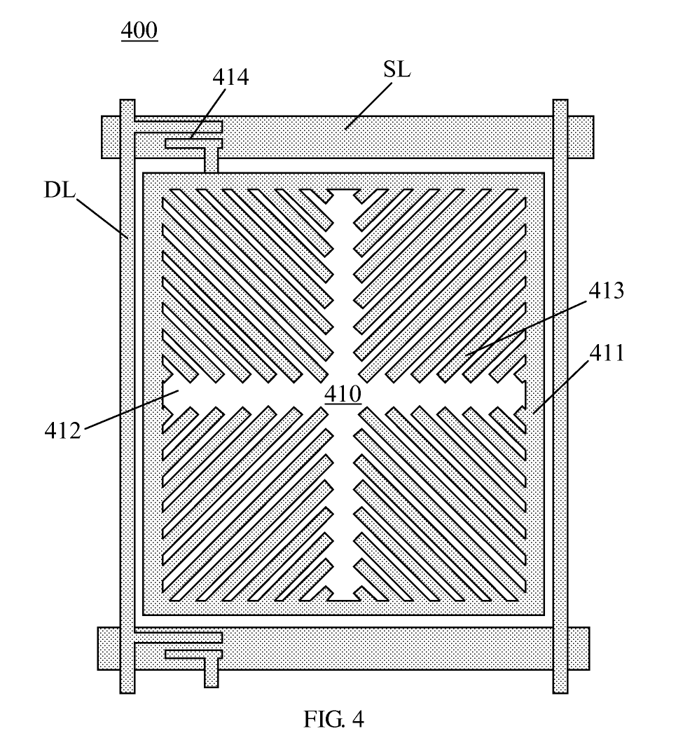

Refer to FIG. 4, which is an enlarged diagram of a pixel in an LCD panel according to a first embodiment of the present invention. According to the present embodiment, a PSVA LCD panel is taken as the LCD panel 400 for illustration. As shown in FIG. 4, the LCD panel 400 comprises a data line DL, a scan line SL, a switch unit 414, and a pixel electrode 410. Preferably, the switch unit 414 is a TFT or any other unit having a similar switch function. As shown in FIG. 4, the pixel electrode 410 is disposed in the pixel domain but the pattern of the pixel electrode 410 is different from that of the aforementioned pixel electrode 110. The pixel electrode 410 of the first embodiment of the present invention comprises a rectangular (or square-shaped) peripheral portion 411 and a plurality of branches 413 surrounded by the peripheral portion 411. At least one opening 412 is located inside a region surrounded by the peripheral portion 411. For example, the opening 412 is located at a center of pixel electrode 410. In the present embodiment, the opening 412 is profiled as a cross. The cross-shaped opening 412 divides the pixel electrode 410 into four roughly equal domains. The plural branches 413 slanted at a 45-degree angle are paved within the four domains.

The peripheral portion 411 is electrically connected to one terminal of the switch unit 414. The switch unit 414 is also electrically connected to the scan line SL and the data line DL. So the voltage applied to the scan line SL can turn on the switch unit 414. Also, by means of the conduction of the switch unit 414 and the peripheral portion 411, the data signal carried by the data line DL can be transmitted to the pixel electrode 410.

The plural branches 413 of the four domains have their individual directions. The included angles between each of the branches 413 in the four domains and the X axis (the scan line SL) are ±45 degrees and ±135 degrees, respectively. According to a preferred embodiment of the present invention, all of the branches 413 of the domains are directed toward the center of the pixel domain. That is, as shown in FIG. 4, the included angle between the branches 413 in the first quadrant and the scan line SL is −135 degrees; the included angle between the branches 413 in the second quadrant and the scan line SL is −45 degrees; the included angle between the branches 413 in the third quadrant and the scan line SL is 45 degrees; the included angle between the branches 413 in the fourth quadrant and the scan line SL is 135 degrees. It should be notified that, however, the included angle between each of the branches 413 of the four domains and the scan line SL is only an embodiment of the present invention. These included angles are not intended to limit the present invention. Designers can design other included angles depending on their demands. Such corresponding changes are also within the scope of the present invention.

Moreover, it is notified that, although the peripheral portion 411 is shaped as a rectangular frame according to the present embodiment, it can be shaped as a circle, a hexagon, a octagon, or any other shape in practical applications. In other words, the peripheral portion 411 is not restricted to being a rectangle.

Refer to FIG. 5, which illustrates an alignment of the LC molecules when a voltage is applied to the pixel electrode 410 shown in FIG. 4. As shown in FIG. 5, when the voltage is applied to the pixel electrode 410, the LC molecules are slanted gradually from the part of the pixel electrode 410 to the outer part of the pixel electrode 410. The slanted angle of the LC molecules in each domain extends in the direction of the branches 413 of the same domain. The slanted LC molecules in the four domains are at ±45 and ±135 degrees, respectively. The slanted directions of the LC molecules are from the center of the pixel domain to four corners of the pixel domain.

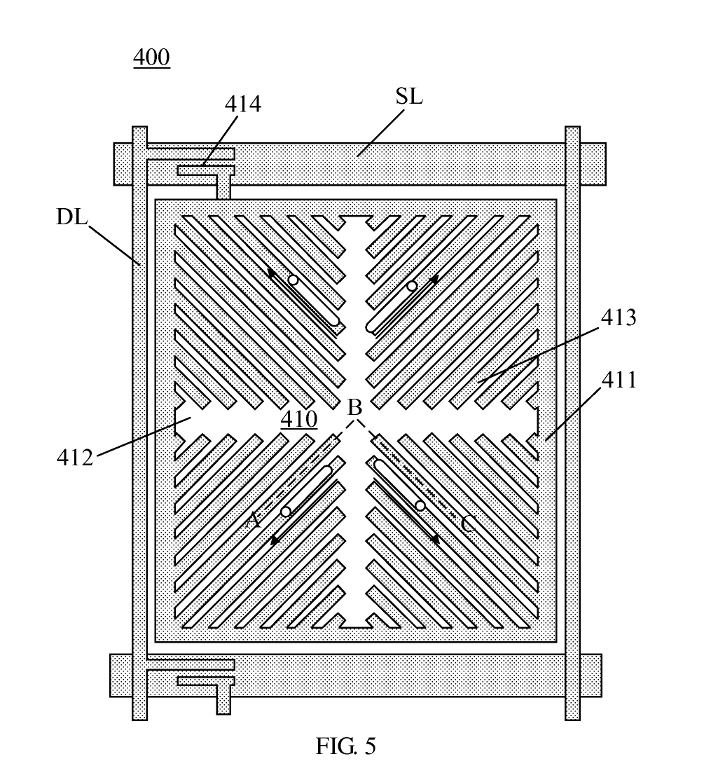

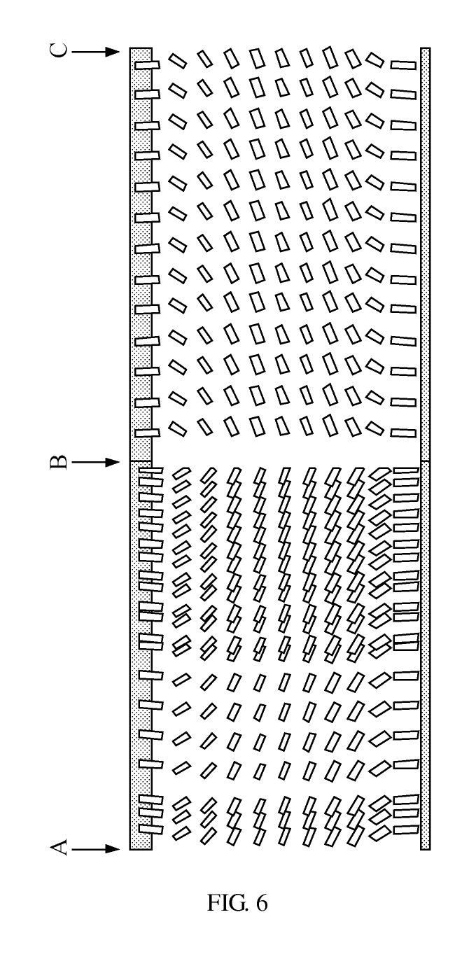

Refer to FIG. 6, which is a cross-sectional view of slanted directions of the LC molecules along a dash line A-B-C shown in FIG. 5. As shown in FIG. 6, on the cross section (perpendicular to the sheet surface) along the dash line shown in FIG. 4, the LC molecules are slanted from the inner part to the outer part and the slanted directions are directed to the four corners of the pixel. As can be seen, the LC molecules are slanted from the center toward the peripheral portion when the voltage is applied to the pixel electrode 410. So the central domain of the pixel electrode 410 can be prevented from being squeezed. Thus, in a preferred embodiment of the present invention, designers can enlarge the domain of the central opening 412 (i.e., the domain without ITO) as much as possible. In this way, the non-opening domain can be greatly reduced and the aperture rate becomes relatively large.

It is notified that, the pattern of the pixel electrode 410 of the first embodiment of the present invention is not difficult to be manufactured for a person skilled in this art; that is, no specific process is required for forming the pattern of the pixel electrode 410. In the manufacturing process, the conventional pixel electrode 100 can be directly replaced by the pattern of the pixel electrode 410. A person skilled in this art should fully understand the manufacturing process and the description as to this is not detailed herein.

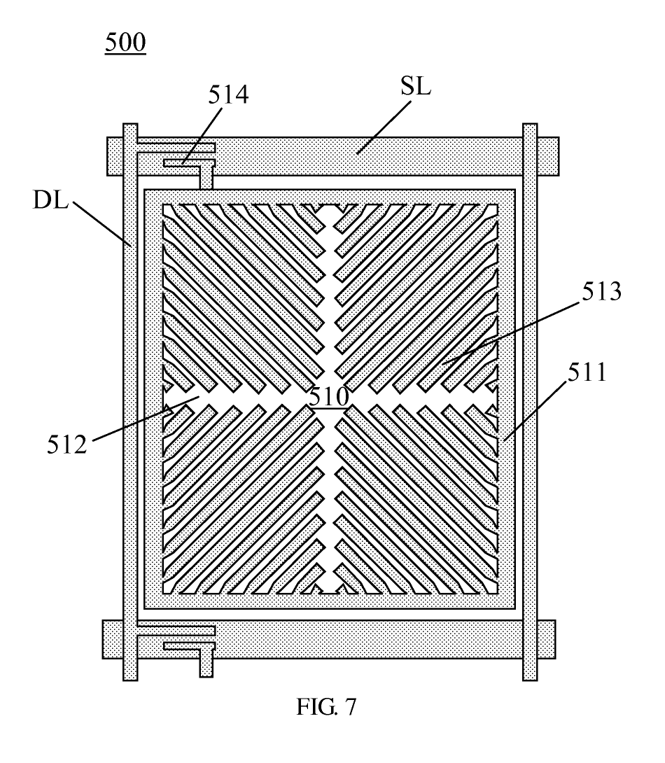

Refer to FIG. 7, which is an enlarged diagram of a pixel in a LCD panel according to a second embodiment of the present invention. As shown in FIG. 7, the LCD panel 500 comprises a data line DL, a scan line SL, a switch unit 514, and a pixel electrode 510. The pixel electrode 510 of the second embodiment of the present invention comprises a peripheral portion 511 and a plurality of branches 513 surrounded by the peripheral portion 511. At least one opening 512 is located inside a region surrounded by the peripheral portion 511. The peripheral portion 511 is electrically connected to one terminal of the switch unit 514. The switch unit 514 is also electrically connected to the scan line SL and the data line DL. So the voltage applied to the scan line SL can turn on the switch unit 514. Also, by means of the conduction of the switch unit 514 and the peripheral portion 511, the data signal carried by the data line DL can be transmitted to the pixel electrode 510. In the present embodiment, the opening 512 is profiled as a cross. The cross-shaped opening 512 divides the pixel electrode 510 into four roughly equal domains. The plural branches 513 slanted at a 45-degree angle are paved within the four domains. The LC molecules are slanted gradually from the inner part of the pixel electrode 510 to the outer part of the pixel electrode 510 when the voltage is applied to the pixel electrode 510. So the central domain of the pixel electrode 510 can be prevented from being squeezed. In the present invention, the non-opening domain can be greatly reduced and the aperture rate becomes relatively large.

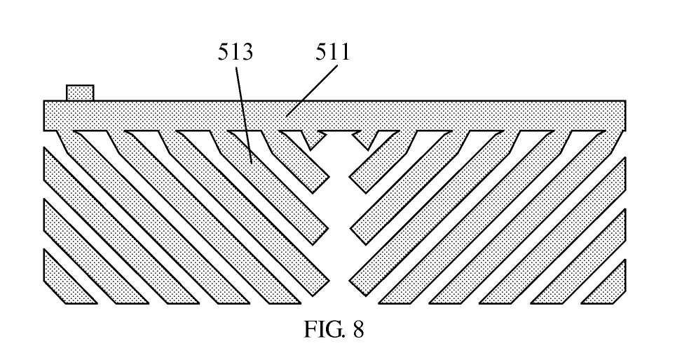

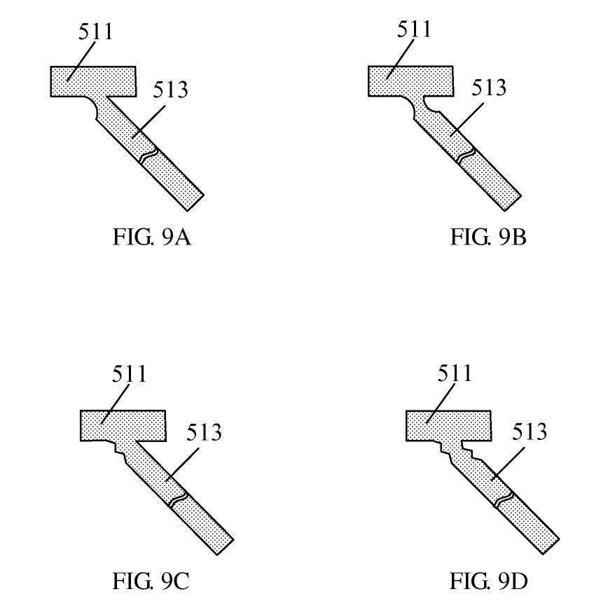

Refer to FIG. 8, which is an enlarged diagram showing the branches 513 of FIG. 7. The difference between the second embodiment and the first embodiment of the present invention is that each branch 513 of the second embodiment has a part connecting to the peripheral portion 511 and said part has a width smaller than respective widths of other parts in each branch 513. For example, the contour of the part where each branch 513 and the peripheral portion 511 are connected is shrunk. It is noted that no matter what kind of approach is utilized to shrink the contour of the part where each branch 513 and the peripheral portion 511 are connected, any other shrinking approach and obtained results are within the scope of the present invention. For example, the part where each branch 513 and the peripheral portion 511 are connected has a curve-shaped edge, such as one concave edge at one side (see FIG. 9A) or two concave edges as two sides (see FIG. 9B); the part where each branch 513 and the peripheral portion 511 are connected has a saw-toothed edge, such as a saw-toothed contour formed at one side (see FIG. 9C) or two sides (see FIG. 9D).

In the second embodiment of the present invention, since the contour of the part where each branch 513 and the peripheral portion 511 are connected is shrunk, the branch near the peripheral portion 511 becomes slimmer. The LC molecules at this part are slanted very well. Therefore, it is unlikely to squeeze other LC molecules in opposite direction, and thus it is beneficial to suppress the appearance of disclination line at the center domain of the pixel electrode 510.

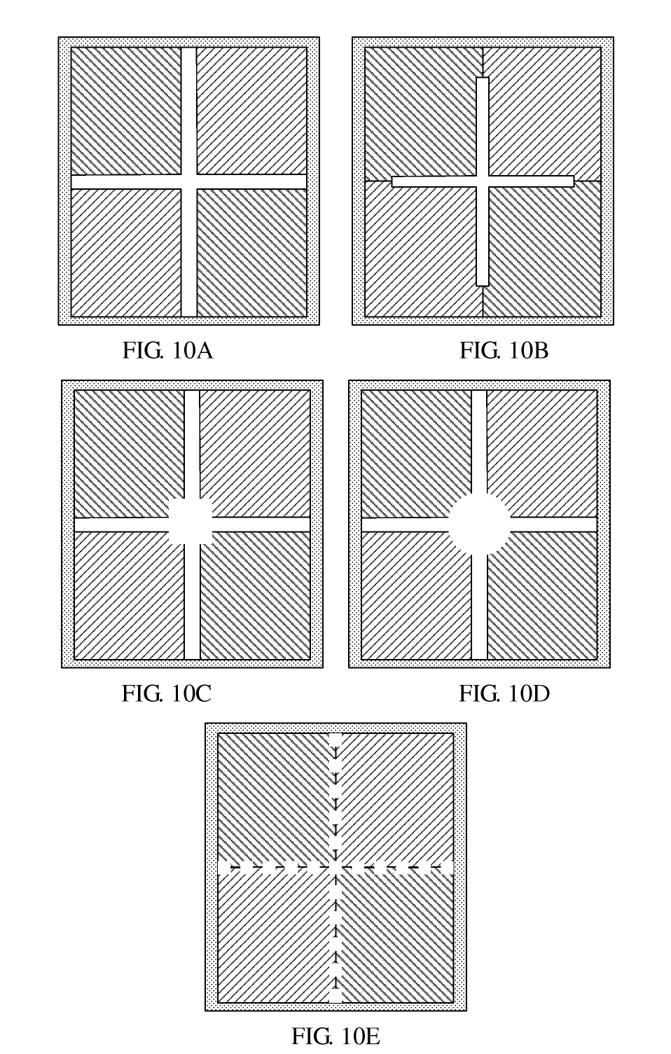

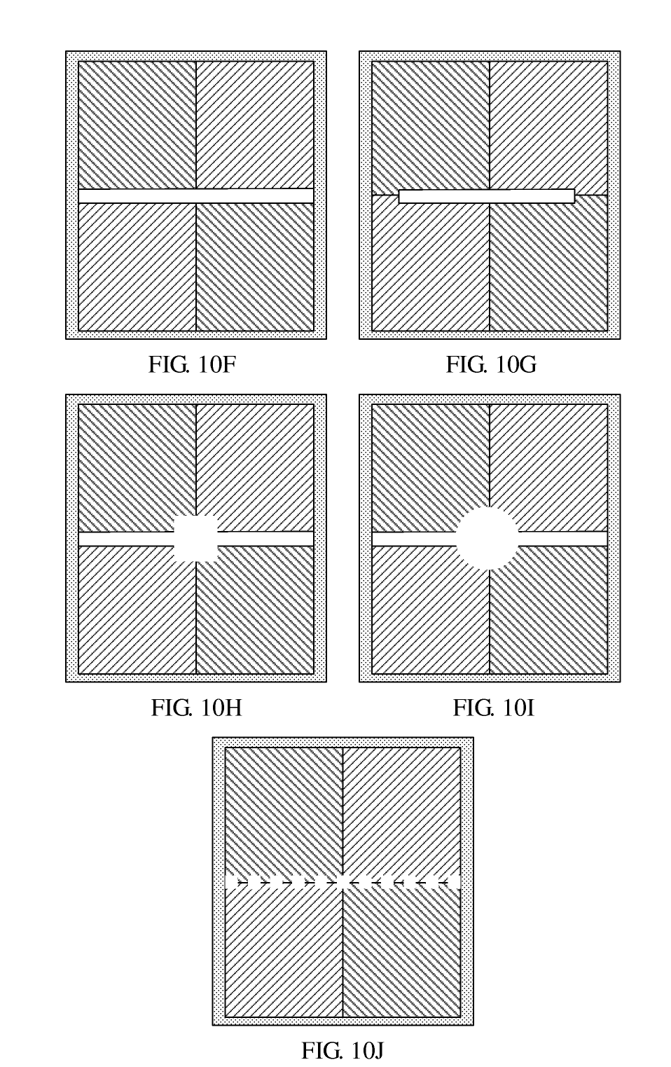

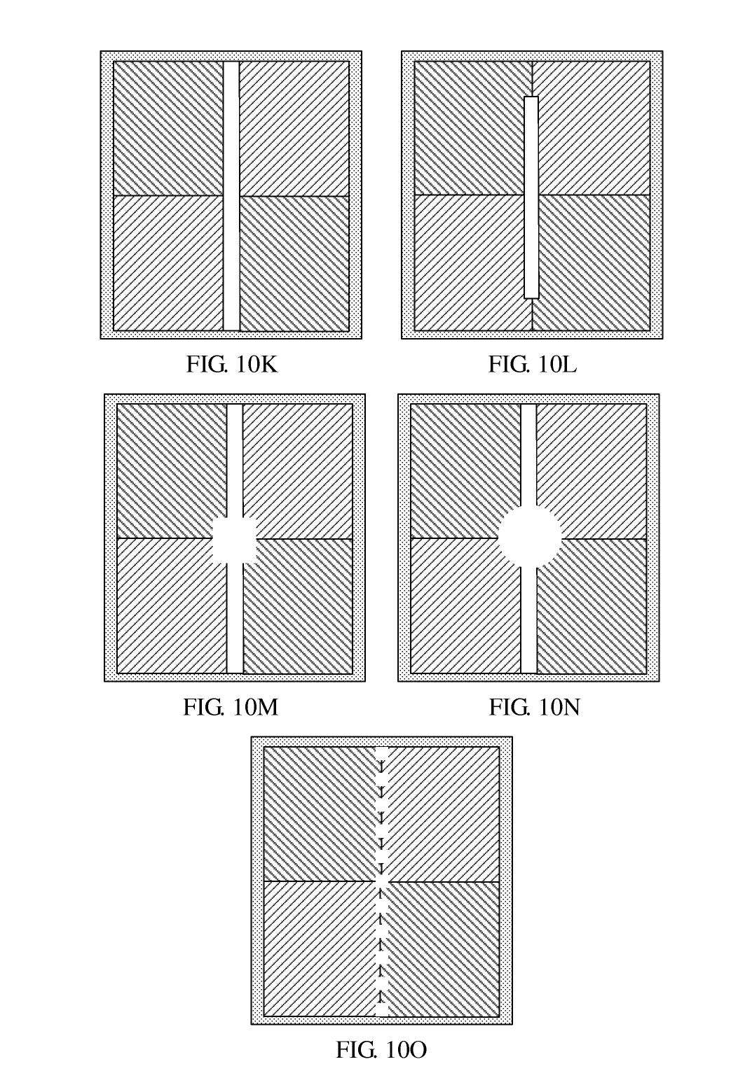

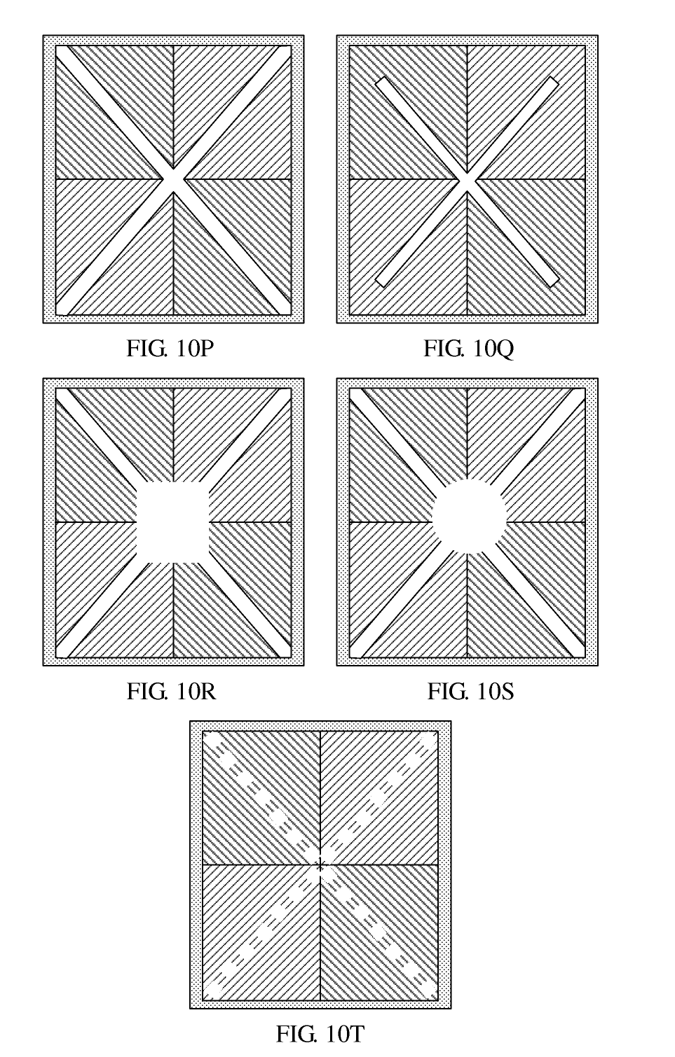

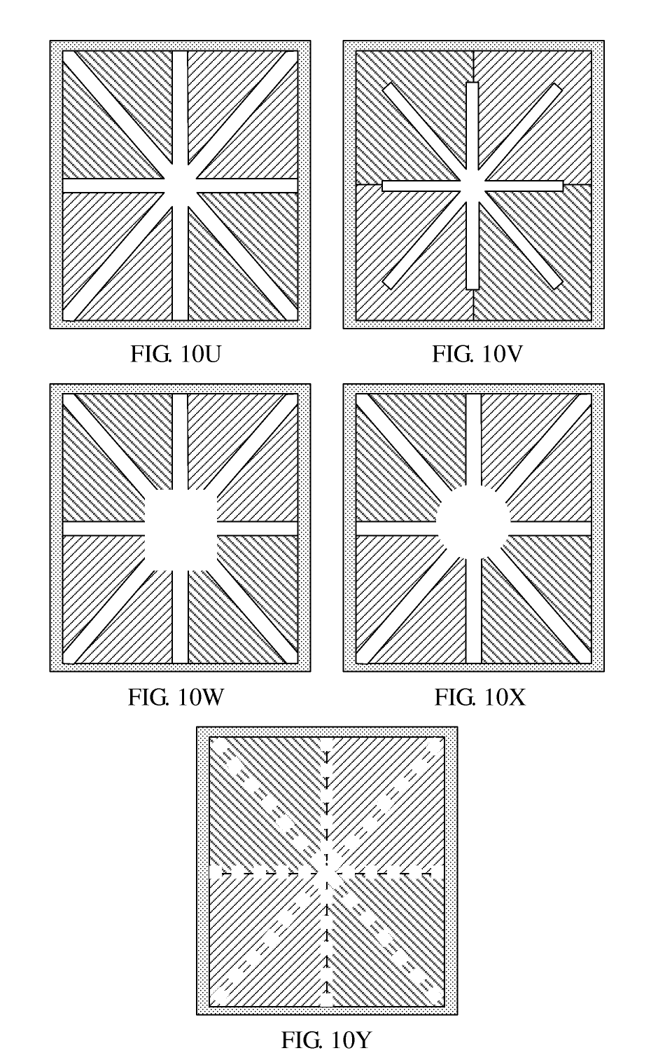

FIGS. 10A to 10E are schematic diagrams showing a pixel electrode having a cross-shaped opening according to a third embodiment of the present invention. The pixel electrode of the third embodiment is developed from the first embodiment or the second embodiment. In the third embodiment, each branch of the pixel electrode has a part connecting to the peripheral portion and said part has a width that can be smaller than respective widths of other parts in each branch. As shown in FIGS. 10A to 10E, the pixel electrode of the third embodiment has a cross-shaped opening. In one embodiment, the minimum distance between the peripheral portion and a contour of the cross-shaped opening is not a zero (see FIG. 10B). In one embodiment, the opening comprises a bulk-shaped opening located at the center of the pixel electrode, and the bulk-shaped opening is selected from a group consisting of a triangle, a rectangle (see FIG. 10C), a star shape, a circle (see FIG. 10D), an ellipse, and a regular polygon. In one embodiment, the cross-shaped opening is constructed by a plurality of discontinuous openings (see FIG. 10E). The cross-shaped opening can make the plural branches form an upper-lower or a left-right mirror-image symmetry.

FIGS. 10F to 10J are schematic diagrams showing a pixel electrode having a horizontal straight opening according to a fourth embodiment of the present invention. The pixel electrode of the fourth embodiment is developed from the first embodiment or the second embodiment. In the fourth embodiment, each branch of the pixel electrode has a part connecting to the peripheral portion and said part has a width that can be smaller than respective widths of other parts in each branch. As shown in FIGS. 10F to 10J, the pixel electrode of the fourth embodiment has a horizontal opening profiled as a straight line. In one embodiment, the minimum distance between the peripheral portion and a contour of the horizontal straight opening is not a zero (see FIG. 10G). In one embodiment, the opening comprises a bulk-shaped opening located at the center of the pixel electrode, and the bulk-shaped opening is selected from a group consisting of a triangle, a rectangle (see FIG. 10H), a star shape, a circle (see FIG. 10I), an ellipse, and a regular polygon. In one embodiment, the horizontal straight opening is constructed by a plurality of discontinuous openings (see FIG. 10J). The horizontal straight opening can make the plural branches form an upper-lower mirror-image symmetry.

FIGS. 10K to 10O are schematic diagrams showing a pixel electrode having a vertical straight opening according to a fifth embodiment of the present invention. The pixel electrode of the fifth embodiment is developed from the first embodiment or the second embodiment. In the fifth embodiment, each branch of the pixel electrode has a part connecting to the peripheral portion and said part has a width that can be smaller than respective widths of other parts in each branch. As shown in FIGS. 10K to 10O, the pixel electrode of the fifth embodiment has a vertical opening profiled as a straight line. In one embodiment, the minimum distance between the peripheral portion and a contour of the vertical straight opening is not a zero (see FIG. 10L). In one embodiment, the opening comprises a bulk-shaped opening located at the center of the pixel electrode, and the bulk-shaped opening is selected from a group consisting of a triangle, a rectangle (see FIG. 10M), a star shape, a circle (see FIG. 10N), an ellipse, and a regular polygon. In one embodiment, the vertical straight opening is constructed by a plurality of discontinuous openings (see FIG. 10O). The vertical straight opening can make the plural branches form a left-right mirror-image symmetry.

FIGS. 10P to 10T are schematic diagrams showing a pixel electrode having an X-shaped opening according to a sixth embodiment of the present invention. The pixel electrode of the sixth embodiment is developed from the first embodiment or the second embodiment. In the sixth embodiment, each branch of the pixel electrode has a part connecting to the peripheral portion and said part has a width that can be smaller than respective widths of other parts in each branch. As shown in FIGS. 10P to 10T, the pixel electrode of the sixth embodiment has an X-shaped opening. In one embodiment, the minimum distance between the peripheral portion and a contour of the X-shaped opening is not a zero (see FIG. 10Q). In one embodiment, the opening comprises a bulk-shaped opening located at the center of the pixel electrode, and the bulk-shaped opening is selected from a group consisting of a triangle, a rectangle (see FIG. 10R), a star shape, a circle (see FIG. 10S), an ellipse, and a regular polygon. In one embodiment, the X-shaped opening is constructed by a plurality of discontinuous openings (see FIG. 10T). The X-shaped opening can make the plural branches form an upper-lower or a left-right mirror-image symmetry.

FIGS. 10U to 10Y are schematic diagrams showing a pixel electrode having a snowflake-like opening according to a seventh embodiment of the present invention. The pixel electrode of the seventh embodiment is developed from the first embodiment or the second embodiment. In the seventh embodiment, each branch of the pixel electrode has a part connecting to the peripheral portion and said part has a width that can be smaller than respective widths of other parts in each branch. As shown in FIGS. 10U to 10Y, the pixel electrode of the seventh embodiment has an opening profiled as a snowflake. In one embodiment, the minimum distance between the peripheral portion and a contour of the snowflake-like opening is not a zero (see FIG. 10V). In one embodiment, the opening comprises a bulk-shaped opening located at the center of the pixel electrode, and the bulk-shaped opening is selected from a group consisting of a triangle, a rectangle (see FIG. 10W), a star shape, a circle (see FIG. 10X), an ellipse, and a regular polygon. In one embodiment, the snowflake-like opening is constructed by a plurality of discontinuous openings (see FIG. 10Y). The snowflake-like opening can divide the plural branches into eight minor-image symmetric domains.

In contrast to the conventional skills, the LCD panel of the present invention comprises a pixel electrode having a specific pattern. The pixel electrode comprises a peripheral portion and branches, and removes an opaque main trunk of the conventional pixel electrode. Therefore, the pixel electrode of the present invention has a larger light transmittable area, thereby providing a LCD panel having a higher aperture rate. Moreover, in the pixel electrode of the present invention, the contour of the part where each branch and the peripheral portion are connected is shrunk. The LC molecules at this part are slanted very well. Therefore, it is unlikely to squeeze other LC molecules in opposite direction, and thus the present invention can solve the problem of disclination line appeared at the center domain of the pixel electrode.

The pixel electrode of the present invention is qualified for being applied to a PSVA LCD panel, a twisted nematic (TN) LCD panel, a pattern vertical alignment (PVA) LCD panel, and so on.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A pixel electrode of a liquid crystal display (LCD) panel, the LCD panel comprising a scan line, a data line, a switch unit, and a pixel domain, the scan line and the data line being electrically connected to the switch unit, the pixel electrode being disposed in the pixel domain, the pixel electrode comprising:
a peripheral portion electrically connected to one terminal of the switch unit;
a plurality of branches surrounded by the peripheral portion and connected to the peripheral portion; and
at least one opening located inside a region surrounded by the peripheral portion, the opening dividing the plural branches into at least two domains;
wherein each branch has a part connecting to the peripheral portion and said part has a width smaller than respective widths of other parts in each branch.

2. The pixel electrode according to claim 1, wherein the part where each branch and the peripheral portion are connected has at least one curve-shaped edge.

3. The pixel electrode according to claim 1, wherein the part where each branch and the peripheral portion are connected has at least one saw-toothed edge.

4. The pixel electrode according to claim 1, wherein the peripheral portion is shaped as a rectangle.

5. The pixel electrode according to claim 1, wherein the opening is profiled as a cross, which divides the plural branches into four domains.

6. The pixel electrode according to claim 5, wherein a direction of the branches of one of the four domains differs from that of the branches of another domain.

7. The pixel electrode according to claim 6, wherein the four domains are mirror-image symmetry.

8. The pixel electrode according to claim 1, wherein the opening is profiled as a straight line, which is parallel to the scan line.

9. The pixel electrode according to claim 1, wherein the opening is profiled as a straight line, which is parallel to the data line.

10. The pixel electrode according to claim 1, wherein the opening is profiled as an X-shaped opening, which divides the plural branches into four domains.

11. The pixel electrode according to claim 1, wherein the opening is profiled as a snowflake, which divides the plural branches into eight domains.

12. The pixel electrode according to claim 1, wherein the opening comprises a bulk-shaped opening, which is located at a center of the pixel electrode.

13. The pixel electrode according to claim 12, wherein the bulk-shaped opening is selected from a group consisting of a triangle, a rectangle, a star shape, a circle, an ellipse, and a regular polygon.

14. The pixel electrode according to claim 1, a minimum distance between the peripheral portion and a contour of the opening is not a zero.

15. The pixel electrode according to claim 1, wherein the opening is constructed by a plurality of discontinuous openings.

16. The pixel electrode according to claim 1, wherein every neighboring two of the plural branches have an equal gap.

17. A liquid crystal display (LCD) panel, the LCD panel comprising a scan line, a data line, a switch unit, a pixel electrode, and a pixel domain, the scan line and the data line being electrically connected to the switch unit, the pixel electrode being disposed in the pixel domain, the pixel electrode comprising:
a peripheral portion electrically connected to one terminal of the switch unit;
a plurality of branches surrounded by the peripheral portion and connected to the peripheral portion; and
at least one opening located inside a region surrounded by the peripheral portion, the opening dividing the plural branches into at least two domains;
wherein each branch has a part connecting to the peripheral portion and said part has a width smaller than respective widths of other parts in each branch.

18. The liquid crystal display panel according to claim 17, wherein the opening is profiled as a cross, which divides the plural branches into four domains.

19. The liquid crystal display panel according to claim 18, wherein a direction of the branches of one of the four domains differs from that of the branches of another domain.

20. The liquid crystal display panel according to claim 17, wherein every neighboring two of the plural branches have an equal gap.
